(19) United States
(12) Patent Application Publication
(10) Pub. No.: US 2002/0168526 A1
(43) Pub. Date: Nov. 14, 2002

(54) Graphite article having predetermined anisotropic characteristics and process therefor

(75) Inventors: Robert Angelo Mercuri, Seven Hills, OH (US); Julian Norley, Chagrin Falls, OH (US); Martin David Smalc, Parma, OH (US)

Correspondence Address: James R. Cartiglia, Graftech Inc., Brandywine West, 1521 Concord Pike, Suite 301, Wilmington, DE, 19803, US

(73) Assignee: Graftech Inc., Lakewood, OH (US)

(21) Appl. No.: 10/185,643

(22) Filed: Jun. 28, 2002

Related U.S. Application Data
(62) Division of application No. 09/826,229, filed on Apr. 4, 2001.

(51) Int. Cl. B32B 9/00

(52) U.S. Cl. 428/408

(57) ABSTRACT

The invention presented is a graphite article having predetermined anisotropic characteristics, as well as a process for preparing the article. More particularly, the article is prepared by a process involving determining the desired anisotropic characteristics for a finished flexible graphite article; intercalating and then exfoliating flakes of graphite to form exfoliated graphite particles; forming a substrate graphite article by compressing the exfoliated graphite particles into a coherent article formed of graphene layers; and producing a controlled directional alignment of the graphene layers in the substrate graphite article to provide a finished graphite article having the desired anisotropic ratio.

### TECHNICAL FIELD

The present invention relates to a graphite article having predetermined anisotropic characteristics, such as anisotropic ratio. More particularly, the invention relates to an article formed from flakes of graphite which have been intercalated and exfoliated and formed into an article having a ratio of in-plane conductivity to through-plane conductivity that has been predetermined and controllably effected. A process for preparing the inventive article is also presented.

### BACKGROUND OF THE INVENTION

With the development of more and more sophisticated technological components, such as electronic components capable of increasing processing speeds and higher frequencies and fuel cell components requiring specific thermal and electrical conductivity, natural graphite has become a material a choice for certain components. Natural graphite is considered a uniquely advantageous material, since it combines desirable properties such as electrical and thermal conductivity and formability with relatively low weight, especially compared to metals like copper or stainless steel. As such, graphite articles have been proposed for various applications, including thermal management in electronics (specifically, thermal interface materials, heat spreaders and heat sinks) and PEM fuel cell components like flow field plates and gas diffusion layers.

With the increased need for heat dissipation from microelectronic devices, thermal management becomes an increasingly important element of the design of electronic products. As noted, both performance reliability and life expectancy of electronic equipment are inversely related to the component temperature of the equipment. For instance, a reduction in the operating temperature of a device such as a typical silicon semiconductor can correspond to an exponential increase in the reliability and life expectancy of the device. Therefore, to maximize the life-span and reliability of a component, maintaining the device operating temperature within the control limits set by the designers is of paramount importance.

Heat sinks are components that facilitate heat dissipation from the surface of a heat source, such as a heat-generating electronic component, to a cooler environment, usually air. In many typical situations, heat transfer between the solid surface of the component and the air is the least efficient within the system, and the solid-air interface thus represents the greatest barrier for heat dissipation. A heat sink seeks to increase the heat transfer efficiency between the components and the ambient air primarily by increasing the surface area that is in direct contact with the air. This allows more heat to be dissipated and thus lowers the device operating temperature. The primary purpose of a heat sink is to help maintain the device temperature below the maximum allowable temperature specified by its designer/manufacturer.

Typically, heat sinks are formed of a metal, especially copper or aluminum, due to the ability of copper to readily absorb and transfer heat about its entire structure. In many applications, copper heat sinks are formed with fins or other structures to increase the surface area of the heat sink, with air being forced across or through the copper fins (such as by a fan) to effect heat dissipation from the electronic component, through the copper heat sink and then to the air.

Limitations exist, however, with the use of copper heat sinks. One limitation relates to copper's relative isotropy—that is, the tendency of a copper structure to distribute heat relatively evenly about the structure. The isotropy of copper means that heat transmitted to a copper heat sink become distributed about the structure rather than being directed to the fins where most efficient transfer to the air occurs. This can reduce the efficiency of heat dissipation using a copper heat sink. In addition, the use of copper or aluminum heat sinks can present a problem because of the weight of the metal, particularly when the heating area is significantly smaller than that of the heat sink. For instance, pure copper weighs 8.96 grams per cubic centimeter (g/cc) and pure aluminum weighs 2.70 g/cc (compare with graphite in the form disclosed herein, which typically weighs between about 0.4 and 1.8 g/cc). In many applications, several heat sinks need to be arrayed on, e.g., a circuit board to dissipate heat from a variety of components on the board. If copper heat sinks are employed, the sheer weight of copper on the board can increase the chances of the board cracking or of other equally undesirable effects, and increases the weight of the component itself. In addition, since copper is a metal and thus has surface irregularities and deformations common to metals, and it is likely that the surface of the electronic component to which a copper heat sink is being joined is also metal or another relatively rigid material such as aluminum oxide or a ceramic material, making a complete connection between a copper heat sink and the component, so as to maximize heat transfer from the component to the copper heat sink, can be difficult without a relatively high pressure mount, which is undesirable since damage to the electronic component could result. Moreover, oxide layers, which are unavoidable in metals, can add a significant barrier to heat transfer, yet are not formed with graphite.

An ion exchange membrane fuel cell, more specifically a proton exchange membrane (PEM) fuel cell, produces electricity through the chemical reaction of hydrogen and oxygen in the air. Within the fuel cell, electrodes denoted as anode and cathode surround a polymer electrolyte and form what is conventionally referred to as a membrane electrode assembly, or MEA. Oftentimes, the electrodes serve the dual function of gas diffusion layer, or GDL, within the fuel cell. A catalyst material stimulates hydrogen molecules to split into hydrogen atoms and then, at the membrane, the atoms each split into a proton and an electron. The electrons are utilized as electrical energy. The protons migrate through the electrolyte and combine with oxygen and electrons to form water.

A PEM fuel cell is advantageously formed of a membrane electrode assembly sandwiched between two graphite flow field plates. Conventionally, the membrane electrode assembly consists of random-oriented carbon fiber paper electrodes (anode and cathode) with a thin layer of a catalyst material, particularly platinum or a platinum group metal coated on isotropic carbon particles, such as lamp black, bonded to either side of a proton exchange membrane disposed between the electrodes. In operation, hydrogen flows through channels in one of the flow field plates to the anode, where the catalyst promotes its separation into hydrogen atoms and thereafter into protons that pass through the membrane and electrons that flow through an external load. Air flows through the channels in the other flow field plate to the cathode, where the oxygen in the air is separated into oxygen atoms, which joins with the protons through the proton exchange membrane and the electrons through the circuit, and combine to form water. Since the membrane is an insulator, the electrons travel through an external circuit in which the electricity is utilized, and join with protons at the cathode. An air stream on the cathode side is one mechanism by which the water formed by combination of the hydrogen and oxygen can be removed. Combinations of such fuel cells are used in a fuel cell stack to provide the desired voltage.

Recently, the use of natural graphite materials have been suggested for use as certain components of a PEM fuel cell. For example, gas diffusion layers and flow field plates made from flexible graphite sheets, such as Grafcell™ advanced flexible graphite materials, available from Graftech Inc. of Lakewood, Ohio, have been employed or disclosed for use in fuel cells.

The different applications for graphite articles discussed above, as well as others not specifically addressed herein, require differing characteristics for optimization. For instance, a heat spreader may comprise a sheet which requires a maximum of thermal conductivity in the in-plane direction of the sheet (i.e., along the major surfaces of the sheet) in order to effectively spread heat as rapidly as possible. As a comparison, a gas diffusion layer (which can also function as an electrode, as noted above) for an electrochemical fuel cell, also generally in the form of a sheet, may require a certain degree of through-plane (i.e., between its major surfaces) electrical conductivity to assist in directing current flow, while still desiring as much in-plane thermal and electrical conductivity as possible.

Graphite is made up of layer planes of hexagonal arrays or networks of carbon atoms. These layer planes of hexagonally arranged carbon atoms are substantially flat and are oriented or ordered so as to be substantially parallel and equidistant to one another. The substantially flat, parallel equidistant sheets or layers of carbon atoms, usually referred to as graphene layers or basal planes, are linked or bonded together and groups thereof are arranged in crystallites. Highly ordered graphites consist of crystallites of considerable size: the crystallites being highly aligned or oriented with respect to each other and having well ordered carbon layers. In other words, highly ordered graphites have a high degree of preferred crystallite orientation. It should be noted that graphites possess anisotropic structures and thus exhibit or possess many properties that are highly directional e.g. thermal and electrical conductivity and fluid diffusion.

Briefly, graphites may be characterized as laminated structures of carbon, that is, structures consisting of superposed layers or laminae of carbon atoms joined together by weak van der Waals forces. In considering the graphite structure, two axes or directions are usually noted, to wit, the “c” axis or direction and the “a” axes or directions. For simplicity, the “c” axis or direction may be considered as the direction perpendicular to the carbon layers. The “a” axes or directions may be considered as the directions parallel to the carbon layers or the directions perpendicular to the “c” direction. The graphites suitable for manufacturing flexible graphite sheets possess a very high degree of orientation.

As noted above, the bonding forces holding the parallel layers of carbon atoms together are only weak van der Waals forces. Natural graphites can be chemically or electrochemically treated so that the spacing between the superposed carbon layers or laminae can be appreciably opened up so as to provide a marked expansion in the direction perpendicular to the layers, that is, in the “c” direction, and thus form an expanded or intumesced graphite structure in which the laminar character of the carbon layers is substantially retained.

Graphite flake which has been expanded, and more particularly expanded so as to have a final thickness or “c” direction dimension which is as much as about 80 or more times the original “c” direction dimension, can be formed without the use of a binder into cohesive or integrated sheets of expanded graphite, e.g. mat, webs, papers, strips, tapes, or the like (typically referred to as “flexible graphite”). The formation of graphite particles which have been expanded to have a final thickness or “c” dimension which is as much as about 80 or more times the original “c” direction dimension into integrated flexible sheets by compression, without the use of any binding material, is believed to be possible due to the mechanical interlocking, or cohesion, which is achieved between the voluminously expanded graphite particles.

In addition to flexibility, the sheet material, as noted above, has also been found to possess a high degree of anisotropy with respect to thermal and electrical conductivity and fluid diffusion, comparable to the natural graphite starting material due to orientation of the expanded graphite particles substantially parallel to the opposed faces of the sheet resulting from compression. Sheet material thus produced has excellent flexibility, good strength and a very high degree of orientation.

Briefly, the process of producing flexible, binderless anisotropic graphite sheet material, e.g. web, paper, strip, tape, foil, mat, or the like, comprises compressing or compacting under a predetermined load and in the absence of a binder, expanded graphite particles which have a “c” direction dimension which is as much as about 80 or more times that of the original particles so as to form a substantially flat, flexible, integrated graphite sheet. The expanded graphite particles that generally are worm-like or vermiform in appearance, once compressed, will maintain the compression set and alignment with the opposed major surfaces of the sheet. The density and thickness of the sheet material can be varied by controlling the degree of compression. The density of the sheet material can be within the range of from about 0.08 g/cc to about 2.0 g/cc. The flexible graphite sheet material exhibits an appreciable degree of anisotropy due to the alignment of graphite particles parallel to the major opposed, parallel surfaces of the sheet. In roll pressed anisotropic sheet material, the thickness, i.e. the direction perpendicular to the opposed, parallel sheet surfaces comprises the “c” direction and the directions ranging along the length and width, i.e. along or parallel to the opposed, major surfaces comprise the “a” directions and the thermal, electrical and fluid diffusion properties of the sheet are very different, by orders of magnitude typically, for the “c” and “a” directions.

With respect to electrical properties, the conductivity of anisotropic flexible graphite sheet is high in the direction parallel to the major faces of the flexible graphite sheet (“a” direction), and substantially less in the direction transverse to the major surfaces (“c” direction) of the flexible graphite sheet. With respect to thermal properties, the thermal conductivity of a flexible graphite sheet in a direction parallel to the major surfaces of the flexible graphite sheet is relatively high, while it is relatively low in the “c” direction transverse to the major surfaces.

Given the different uses to which graphite articles produced from flexible graphite sheet are applied, it would be highly advantageous to predetermine or control the anisotropic ratio of the article, in order to optimize certain functional characteristics of the graphite articles for the particular end use. By anisotropic ratio is meant, with respect to either thermal or electrical conductivity, the ratio of in-plane conductivity to through-plane conductivity.

### SUMMARY OF THE INVENTION

The invention presented is a graphite article comprising flakes of natural graphite which have been exfoliated and compressed into a graphite article having predetermined anisotropic characteristics, such as anisotropic ratio, more preferably an anisotropic ratio between about 2 and about 250 (with respect to thermal anisotropy) or between about 200 and about 5000 (with respect to electrical anisotropy). The anisotropic ratio of the inventive article (with respect to thermal conductivity, electrical conductivity or a balance of thermal and electrical conductivity in a controlled manner) can be produced by controlled directional alignment of the graphene layers. This can be accomplished, for instance, by control of the flake size of the flakes of graphite prior to intercalation and exfoliation; molding of the exfoliated graphite particles to form the finished graphite article; mechanically altering the orientation of the particles of the graphite article (effected, for instance, by impaction of the graphite article, the application of shear force to the flexible graphite article, embossing of the flexible graphite article, localized impaction of the graphite article, or the combination thereof); or combinations of any of the foregoing.

In another aspect of the invention, a process for producing a finished graphite article having predetermined anisotropic characteristics is presented. The process involves determining the desired anisotropic charactertistics for a finished flexible graphite article; intercalating and then exfoliating flakes of graphite to form exfoliated graphite particles; forming a substrate graphite article by compressing the exfoliated graphite particles into a coherent article formed of graphene layers; directionally aligning the graphene layers in the substrate graphite article to provide a finished graphite article having the desired anisotropic characteristics.

### BRIEF DESCRIPTION OF THE DRAWINGS

The present invention will be better understood and its advantages more apparent in view of the following detailed description, especially when read with reference to the appended drawings, wherein:

FIGS. 1, 1(A) are photomicrographs, at a magnification of 50× of a cross-section of one of the walls of an embossed flexible graphite sheet prepared in accordance with the present inventions, showing morphologies achievable using void-free (FIG. 1) and non-void-free (FIG. 1(A)) flexible graphite sheet;

FIG. 2 is a partial cross-sectional view of an embodiment of an embossing apparatus useful to produce the flexible graphite sheets of FIGS. 1, 1(A);

FIG. 2(A) is a partial cross-sectional view of an embodiment of the embossing apparatus of FIG. 2, seen immediately as embossing begins;

FIG. 2(B) is the embossing apparatus of FIG. 2, seen as embossing occurs;

FIG. 2(C) shows a perspective view of the embossing apparatus of FIG. 2;

FIG. 3 is an enlarged sketch of a cross-section of a flexible graphite sheet;

FIGS. 4(A)-4(C) are sketches of a flexible graphite sheet showing different patterns of localized impaction;

FIG. 5 shows a perspective view of an apparatus for effecting the localized surface impaction of the sheet of FIG. 3;

FIG. 6 is an enlarged sketch of the sheet of FIG. 5 after compression.

FIG. 6(A) is a side elevation view of the sheet of FIG. 6 subsequent to compression of the deformed surfaces to planar form;

FIG. 7 is an enlarged side elevation view of the sheet of FIG. 3 which is transversely deformed at both opposed surfaces; and

FIG. 7(A) is a side elevation view of the sheet of FIG. 7 subsequent to compression of the deformed surfaces to planar form.

### DETAILED DESCRIPTION OF THE INVENTION

Graphite is a crystalline form of carbon comprising atoms covalently bonded in flat layered planes with weaker bonds between the planes. By treating particles of graphite, such as natural graphite flake, with an intercalant of, e.g. a solution of sulfuric and nitric acid, the crystal structure of the graphite reacts to form a compound of graphite and the intercalant. The treated particles of graphite are hereafter referred to as “particles of intercalated graphite.” Upon exposure to high temperature, the intercalant within the graphite decomposes and volatilizes, causing the particles of intercalated graphite to expand in dimension as much as about 80 or more times its original volume in an accordion-like fashion in the “c” direction, i.e. in the direction perpendicular to the crystalline planes of the graphite. The exfoliated graphite particles are vermiform in appearance, and are therefore commonly referred to as worms. The worms may be compressed together into flexible sheets that, unlike the original graphite flakes, can be formed and cut into various shapes and can also be provided with small transverse openings by deforming mechanical impact.

Graphite starting materials suitable for use in the present invention include highly graphitic carbonaceous materials capable of intercalating organic and inorganic acids as well as halogens and then expanding when exposed to heat. These highly graphitic carbonaceous materials most preferably have a degree of graphitization of about 1.0. As used in this disclosure, the term “degree of graphitization” refers to the value g according to the formula:

$$g = \frac{3.45 - d ( 002 )}{0.095}$$

where d(002) is the spacing between the graphitic layers of the carbons in the crystal structure measured in Angstrom units. The spacing d between graphite layers is measured by standard X-ray diffraction techniques. The positions of diffraction peaks corresponding to the (002), (004) and (006) Miller Indices are measured, and standard least-squares techniques are employed to derive spacing which minimizes the total error for all of these peaks. Examples of highly graphitic carbonaceous materials include natural graphites from various sources, as well as other carbonaceous materials such as carbons prepared by chemical vapor deposition and the like. Natural graphite is most preferred.

The graphite starting materials used in the present invention may contain non-carbon components so long as the crystal structure of the starting materials maintains the required degree of graphitization and they are capable of exfoliation. Generally, any carbon-containing material, the crystal structure of which possesses the required degree of graphitization and which can be intercalated and exfoliated, is suitable for use with the present invention. Such graphite preferably has an ash content of less than about twenty-five, more preferably less than about ten, weight percent. Most preferably, the graphite employed for the present invention will have a purity of at least about 94%. In the most preferred embodiment, the graphite employed will have a purity of at least about 99%.

A common method for manufacturing graphite sheet is described by Shane et al. in U.S. Pat. No. 3,404,061, the disclosure of which is incorporated herein by reference. In the typical practice of the Shane et al. method, natural graphite flakes are intercalated by dispersing the flakes in a solution containing e.g., a mixture of nitric and sulfuric acid, advantageously at a level of about 20 to about 300 parts by weight of intercalant solution per 100 parts by weight of graphite flakes (pph). The intercalation solution contains oxidizing and other intercalating agents known in the art. Examples include those containing oxidizing agents and oxidizing mixtures, such as solutions containing nitric acid, potassium chlorate, chromic acid, potassium permanganate, potassium chromate, potassium dichromate, perchloric acid, and the like, or mixtures, such as for example, concentrated nitric acid and chlorate, chromic acid and phosphoric acid, sulfuric acid and nitric acid, or mixtures of a strong organic acid, e.g. trifluoroacetic acid, and a strong oxidizing agent soluble in the organic acid. Alternatively, an electric potential can be used to bring about oxidation of the graphite. Chemical species that can be introduced into the graphite crystal using electrolytic oxidation include sulfuric acid as well as other acids.

In a preferred embodiment, the intercalating agent is a solution of a mixture of sulfuric acid, or sulfuric acid and phosphoric acid, and an oxidizing agent, i.e. nitric acid, perchloric acid, chromic acid, potassium permanganate, hydrogen peroxide, iodic or periodic acids, or the like. The intercalation solution can also possibly contain metal halides such as ferric chloride, and ferric chloride mixed with sulfuric acid, or a halide, such as bromine as a solution of bromine and sulfuric acid or bromine in an organic solvent.

The quantity of intercalation solution may range from about 20 to about 150 pph and more typically about 50 to about 120 pph. After the flakes are intercalated, any excess solution is drained from the flakes and the flakes are water-washed. Alternatively, the quantity of the intercalation solution may be limited to between about 10 and about 50 pph, which permits the washing step to be eliminated as taught and described in U.S. Pat. No. 4,895,713, the disclosure of which is also herein incorporated by reference.

The particles of graphite flake treated with intercalation solution can optionally be contacted, e.g. by blending, with a reducing organic agent selected from alcohols, sugars, aldehydes and esters which are reactive with the surface film of oxidizing intercalating solution at temperatures in the range of 25° C. and 125° C. Suitable specific organic agents include hexadecanol, octadecanol, 1-octanol, 2-octanol, decylalcohol, 1, 10 decanediol, decylaldehyde, 1-propanol, 1,3 propanediol, ethyleneglycol, polypropylene glycol, dextrose, fructose, lactose, sucrose, potato starch, ethylene glycol monostearate, diethylene glycol dibenzoate, propylene glycol monostearate, glycerol monostearate, dimethyl oxylate, diethyl oxylate, methyl formate, ethyl formate, ascorbic acid and lignin-derived compounds, such as sodium lignosulfate. The amount of organic reducing agent is suitably from about 0.5 to 4% by weight of the particles of graphite flake.

The use of an expansion aid applied prior to, during or immediately after intercalation can also provide improvements. Among these improvements can be reduced exfoliation temperature and increased expanded volume (also referred to as “worm volume”). An expansion aid in this context will advantangeously be an organic material sufficiently soluble in the intercalation solution to achieve an improvement in expansion. More narrowly, organic materials of this type that contain carbon, hydrogen and oxygen, preferably exclusively, may be employed. Carboxylic acids have been found especially effective. A suitable carboxylic acid useful as the expansion aid can be selected from aromatic, aliphatic or cycloaliphatic, straight chain or branched chain, saturated and unsaturated monocarboxylic acids, dicarboxylic acids and polycarboxylic acids which have at least 1 carbon atom, and preferably up to about 15 carbon atoms, which is soluble in the intercalation solution in amounts effective to provide a measurable improvement of one or more aspects of exfoliation. Suitable organic solvents can be employed to improve solubility of an organic expansion aid in the intercalation solution.

Representative examples of saturated aliphatic carboxylic acids are acids such as those of the formula H(CH₂)ₙCOOH wherein n is a number of from 0 to about 5, including formic, acetic, propionic, butyric, pentanoic, hexanoic, and the like. In place of the carboxylic acids, the anhydrides or reactive carboxylic acid derivatives such as alkyl esters can also be employed. Representative of alkyl esters are methyl form ate and ethyl formate. Sulfuric acid, nitric acid and other known aqueous intercalants have the ability to decompose formic acid, ultimately to water and carbon dioxide. Because of this, formic acid and other sensitive expansion aids are advantageously contacted with the graphite flake prior to immersion of the flake in aqueous intercalant. Representative of dicarboxylic acids are aliphatic dicarboxylic acids having 2-12 carbon atoms, in particular oxalic acid, fumaric acid, malonic acid, maleic acid, succinic acid, glutaric acid, adipic acid, 1,5-pentanedicarboxylic acid, 1,6-hexanedicarboxylic acid, 1,10-decanedicarboxylic acid, cyclohexane-1,4-dicarboxylic acid and aromatic dicarboxylic acids such as phthalic acid or terephthalic acid. Representative of alkyl esters are dimethyl oxylate and diethyl oxylate. Representative of cycloaliphatic acids is cyclohexane carboxylic acid and of aromatic carboxylic acids are benzoic acid, naphthoic acid, anthranilic acid, p-aminobenzoic acid, salicylic acid, o-, m- and p-tolyl acids, methoxy and ethoxybenzoic acids, acetoacetamidobenzoic acids and, acetamidobenzoic acids, phenylacetic acid and naphthoic acids. Representative of hydroxy aromatic acids are hydroxybenzoic acid, 3-hydroxy-1-naphthoic acid, 3-hydroxy-2-naphthoic acid, 4-hydroxy-2-naphthoic acid, 5-hydroxy-1-naphthoic acid, 5-hydroxy-2-naphthoic acid, 6-hydroxy-2-naphthoic acid and 7-hydroxy-2-naphthoic acid. Prominent among the polycarboxylic acids is citric acid.

The intercalation solution will be aqueous and will preferably contain an amount of expansion aid of from about 1 to 10%, the amount being effective to enhance exfoliation. In the embodiment wherein the expansion aid is contacted with the graphite flake prior to or after immersing in the aqueous intercalation solution, the expansion aid can be admixed with the graphite by suitable means, such as a V-blender, typically in an amount of from about 0.2% to about 10% by weight of the graphite flake.

After intercalating the graphite flake, and following the blending of the intercalant coated intercalated graphite flake with the organic reducing agent, the blend is exposed to temperatures in the range of 25° to 125° C. to promote reaction of the reducing agent and intercalant coating. The heating period is up to about 20 hours, with shorter heating periods, e.g., at least about 10 minutes, for higher temperatures in the above-noted range. Times of one half hour or less, e.g., on the order of 10 to 25 minutes, can be employed at the higher temperatures.

The thus treated particles of graphite are sometimes referred to as “particles of intercalated graphite.” Upon exposure to high temperature, e.g. temperatures of at least about 160° C. and especially about 700° C. to 1000° C. and higher, the particles of intercalated graphite expand as much as about 80 to 1000 or more times their original volume in an accordion-like fashion in the c-direction, i.e. in the direction perpendicular to the crystalline planes of the constituent graphite particles. The expanded, i.e. exfoliated, graphite particles are vermiform in appearance, and are therefore commonly referred to as worms. The worms may be compressed together into flexible sheets that, unlike the original graphite flakes, can be formed and cut into various shapes and/or provided with small transverse openings by deforming mechanical impact.

Flexible graphite sheet and foil are coherent, with good handling strength, and are suitably compressed, e.g. by roll-pressing, to a thickness of about 0.075 mm to 3.75 mm and a typical density of about 0.1 to 1.5 grams per cubic centimeter (g/cc). From about 1.5-30% by weight of ceramic additives can be blended with the intercalated graphite flakes as described in U.S. Pat. No. 5,902,762 (which is incorporated herein by reference) to provide enhanced resin impregnation in the final flexible graphite product. The additives include ceramic fiber particles having a length of about 0.15 to 1.5 millimeters. The width of the particles is suitably from about 0.04 to 0.004 mm. The ceramic fiber particles are non-reactive and non-adhering to graphite and are stable at temperatures up to about 1100° C., preferably about 1400° C. or higher. Suitable ceramic fiber particles are formed of macerated quartz glass fibers, carbon and graphite fibers, zirconia, boron nitride, silicon carbide and magnesia fibers, naturally occurring mineral fibers such as calcium metasilicate fibers, calcium aluminum silicate fibers, aluminum oxide fibers and the like.

The flexible graphite sheet can also, at times, be advantageously treated with resin and the absorbed resin, after curing, enhances the moisture resistance and handling strength, i.e. stiffness, of the flexible graphite sheet, as well as “fixing” the graphite structure as formed (especially the “aligned” graphene layers). Suitable resin content is preferably at least about 5% by weight, more preferably about 10 to 35% by weight, and suitably up to about 60% by weight. Resins found especially useful in the practice of the present invention include acrylic-, epoxy- and phenolic-based resin systems, or mixtures thereof. Suitable epoxy resin systems include those based on diglycidyl ether of bisphenol A (DGEBA) and other multifunctional resin systems; phenolic resins that can be employed include resole and novolak phenolics. Typically, but not necessarily, the resin system is solvated to facilitate application into the flexible graphite sheet. In a typical resin impregnation step, the flexible graphite sheet is passed through a vessel and impregnated with the resin system from, e.g. spray nozzles, the resin system advantageously being “pulled through the mat” by means of a vacuum chamber. The resin is thereafter preferably dried, reducing the tack of the resin.

It is generally accepted that flexible graphite sheet has an anisotropic ratio, with respect to thermal conductivity, of between about 20-30 (i.e., about 150-200 watts per meter-° C. (W/m° C.) for the in-plane direction vs. about 7 W/mr° C. for the through-plane direction); typical anisotropic ratios with respect to electrical conductivity are in the range of about 1600 to 2000 (i.e., about 125,000 siemens/meter (S/m) for in-plane electrical conductivity vs. about 70 S/m for through-plane electrical conductivity). As noted above, however, the ability to “engineer” or predetermine the anisotropic ratio for specific end uses would be highly advantageous. For instance, a thermal anisotropic ratio of at least about 40, and more preferably at least about 70, would be highly desirable for heat spreader applications. In fact, for most heat management applications, including heat sinks and thermal interfaces, a thermal anisotropic ratio of at least about 160 is most preferred.

Likewise, an electrical anisotropic ratio of at least about 2200 is desirable for many applications, in order to maximize directional current flow while still maintaining the weight advantages of the use of graphite. In addition, for electrochemical fuel cell components, it is desirable to achieve a balance between electrical and thermal anisotropic ratios, to optimize current flow while efficiently ridding the fuel cell of heat. Most desirably, a fuel cell component will have an electrical anisotropic ratio of less than about 1500, combined with a thermal anisotropic ratio of greater than about 70.

To that end, a graphite article, specifically an article formed of compressed particles of exfoliated graphite, can be produced so as to have predetermined anisotropic characteristics, more particularly, a predetermined anisotropic ratio. To do so, the article is produced so as to have controlled directional alignment of the graphene layers. More specifically, the greater the directional alignment of graphene layers, the higher the anisotropic ratio. Directional alignment of the graphene layers can be accomplished by, inter alia, control of the flake size of the flakes of graphite prior to intercalation and exfoliation; molding of the exfoliated graphite particles to form the finished graphite article; mechanically altering the orientation of the particles of the graphite article (effected, for instance, by compaction of the substrate graphite article, the application of shear force to the substrate flexible graphite article, embossing of the graphite article, localized impaction of the graphite article, or the combination thereof); or combinations thereof.

For instance, the use of smaller flakes prior to intercalation and exfoliation creates a graphite article having reduced directional alignment of its graphene layers (and, thus, a lower anisotropic ratio than observed with larger flakes). Contrariwise, the application of pressure through compaction (such as through die pressing using, for instance, a reciprocal platen or flat press) or shear force (such as through calendering or roll pressing) tends to increase directional alignment (and, thus, the anisotropic ratio), although the specific manner of pressure application is relevant: the application of shear force to the article creates a greater degree of directional alignment and, therefore, higher anisotropic ratio than compaction which creates a lesser degree of directional alignment, and, therefore, a relatively lower anisotropic ratio.

For example, and more specifically, to decrease the anisotropic ratio of a graphite article, it can be formed using graphite flake sized such that at least about 70% by weight passes through an 80 mesh screen (referred to as −80 mesh) (unless otherwise indicated, all references to mesh sizes herein are to U.S. standard screens). Indeed, the graphite flake can be sized such that at least about 50% by weight passes through an 80 mesh screen but not a 140 mesh screen (referred to as 80×140 mesh) and has a moisture content of no greater than about 1.0%. In fact, the smaller the flake, the less directional alignment and, thus, the smaller anisotropic ratio. Therefore, to achieve an even smaller anisotropic ratio (i.e., greater isotropy), flake sized such that it passes through a 140 mesh screen is preferred.

Molding of a graphite article, specifically, forcing expanded graphite particles (with or without resin) into a mold by isostatic or die pressing, can also control the directional alignment of the constituent graphene layers. Molding is generally accomplished under pressures which can range from about 7 megaPascals (mPa) to about 700 mPa or higher, with the higher pressures creating greater directional alignment of the graphene layers.

Mechanical alteration of the alignment of the graphene layers through the application of pressure can also be used advantageously to control and adjust the morphology and functional characteristics of the final graphite article, and thus the directional alignment of its graphene layers. More particularly, the application of pressure can be tailored to achieve the desired characteristics, to the extent possible. Pressure can increase the in-plane thermal conductivity of the graphite article to conductivities which are equal to or even greater than that of pure copper, while the density remains a fraction of that of pure copper. Moreover, the anisotropic ratio of the resulting “aligned” articles is substantially higher than for the “pre-aligned” articles, ranging from at least about 70 to up to about 160 and higher (with respect to thermal anisotropy).

Mechanical alteration of graphene layer alignment can also be effected through embossing, especially when combined with void control. More particularly, especially when the graphite article is intended for use as a component in an electrochemical fuel cell, a resin-impregnated flexible graphite sheet can be formed so as to be relatively void-free, to optimize electrical and thermal conductivities for fuel cell applications. This can be accomplished, for instance, by calendering or compacting the sheet so as to have a relatively void-free condition (as indicated, for instance, by a density of at least about 1.5 g/cc, depending on resin content), which leads to production of an article having a relatively high thermal anisotropic ratio (potentially on the order of about 160 or higher). Where a lower anisotropic ratio is desired, such as in certain heat spreader applications, a higher void condition is preferred, which is indicated by a density in the range of about 0.4 to about 1.4 g/cc for a graphite article saturated with resin for rigidity in application and to fix the final morphology.

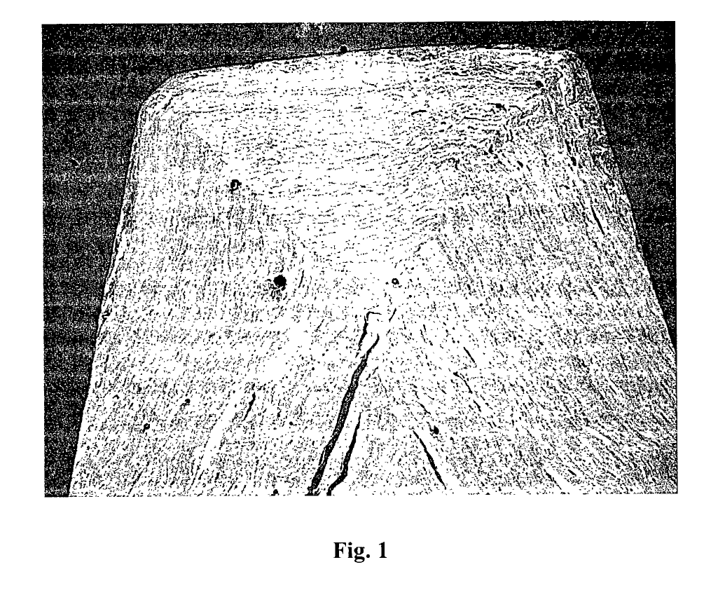

Referring now to FIGS. 1, 1(A), photomicrographs of a cross section of a wall of each of two sheets prepared using the process of the present invention are presented. The sheet of FIG. 1 was calendered to a relatively void-free condition prior to embossing. The sheet of FIG. 1(A) was not brought to a void-free condition prior to embossing. The differences in morphology (i.e., directional alignment) are apparent. It can readily be seen in FIG. 1 that the graphene layers are more aligned with (i.e., parallel to) the surfaces of the wall. Indeed, an “inverted triangle” region is evident at the upper portion of the wall and there appears a line of intersection where the graphite flow fronts meet, essentially dividing the internal structure of the wall into relatively symmetric parts. When this is contrasted with the wall of FIG. 1(A), the structure created by embossing/void control is apparent. As would be familiar to the skilled artisan, the relative amount of structure in an embossed flexible graphite wall can and will lead to differing anisotropic properties, as described above.

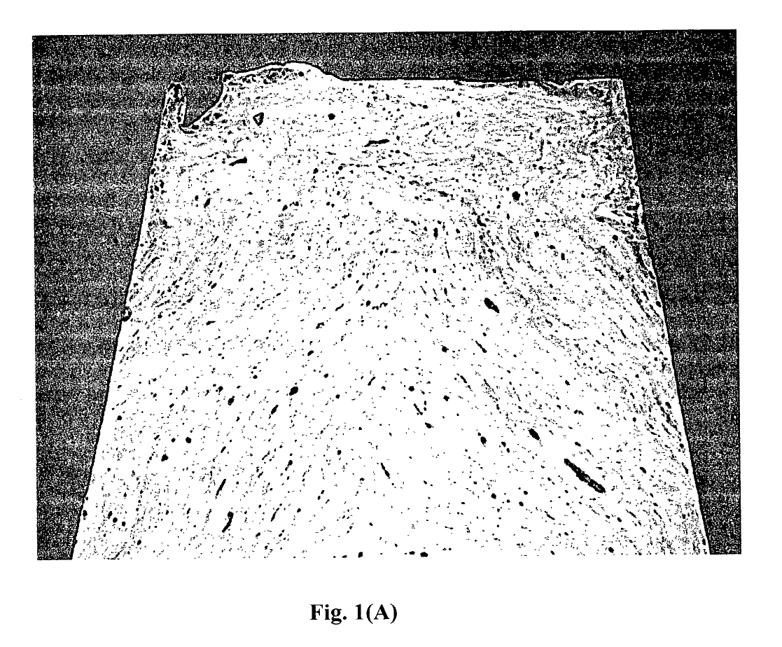

As illustrated in FIGS. 2-2(C), an embossing apparatus 10 for accomplishing this generally comprises two opposed elements 20 and 30, at least one of which is an embossing element 20, and has an embossing pattern thereon. The embossing pattern is formed by arraying a series of walls 22, having tops, or lands, 22a having a predetermined height from the surface of embossing element 20, separated by channel floors 24, about the surface of embossing element 20. Typically, channel floors 24 are in fact the surface of embossing element 20. Landing element 30 preferably comprises a generally flat-surfaced element against which embossing element 20 operates to force the embossing pattern onto the resin-impregnated flexible graphite sheet. The impact surface 32 of landing element 30 can also have textures or other artifacts to facilitate the embossing process or apply a desired texture or pattern to the non-embossed surface of the flexible graphite sheet.

Embossing element 20 and landing element 30 can comprise rollers, plates, a combination thereof, or other structures, provided they are capable of cooperating to emboss a pattern on a flexible graphite sheet, and preferably comprise rollers, as shown in FIG. 2(C). Embossing element 20 and landing element 30 are arrayed in embossing apparatus 10 such that surface 32 of landing element 30 is separated from channel floors 24 of embossing element 20 by a distance “d” which is at least equal to the height of walls 22. Indeed, in the most preferred embodiment, surface 32 of landing element 30 is separated from channel floors 24 of embossing element 20 by distance “d” which is equal to the height of walls 22 plus the desired thickness of the embossed flexible graphite sheet 100 at the location of sheet floors of flexible graphite sheet 100, (i.e., between the walls of sheet 100).

The calendered and resin-impregnated flexible graphite sheet 100a is formed so as to have a thickness in the region of the embossing pattern prior to embossing which is less than distance “d”, but greater than the distance between surface 32 of landing element 30 and walls 22 of embossing element 20, as illustrated in FIG. 2. During embossing, material (i.e., graphite and resin) in sheet 100a flow from the area of sheet 100a which encounters pressure from lands 22a of walls 22 of embossing element 20 pressing against sheet 100a to the gap 24a between sheet 100a and channel floors 24 of embossing element 20, as illustrated in FIGS. 2-2(B). This “rearrangement” of the graphite/resin of calendered and resin-impregnated flexible graphite sheet 100a is surprising, and leads to an embossed flexible graphite sheet 100, having sheet floors 102 and sheet lands 104 which form a channel pattern corresponding to the embossing pattern of embossing element 20 (as shown in FIGS. 2 and 2(A)).

Yet another manner of providing engineered directional alignment of the graphene layers of a graphite article is through mechanical alteration of the graphene layers in specified regions of the article. The regions are mechanically altered by localized impaction of a surface of a graphite article, such as a flexible graphite sheet, to transversely deform the surface and displace graphite within the sheet at a plurality of locations and subsequently pressing the deformed, impacted surface to a planar surface.

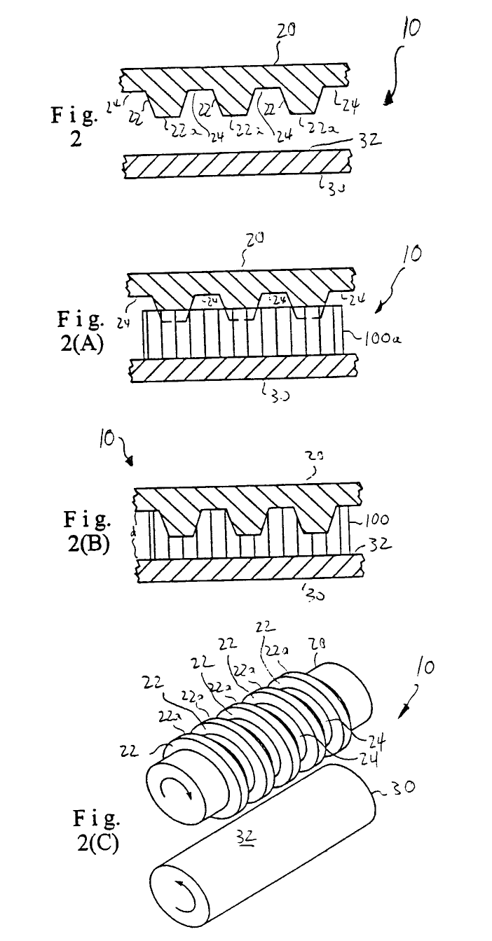

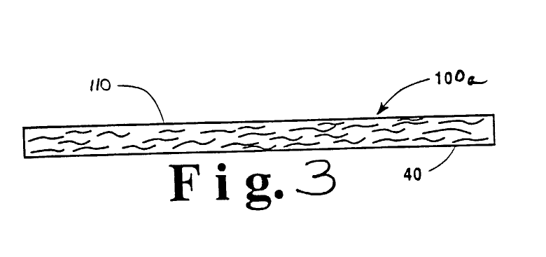

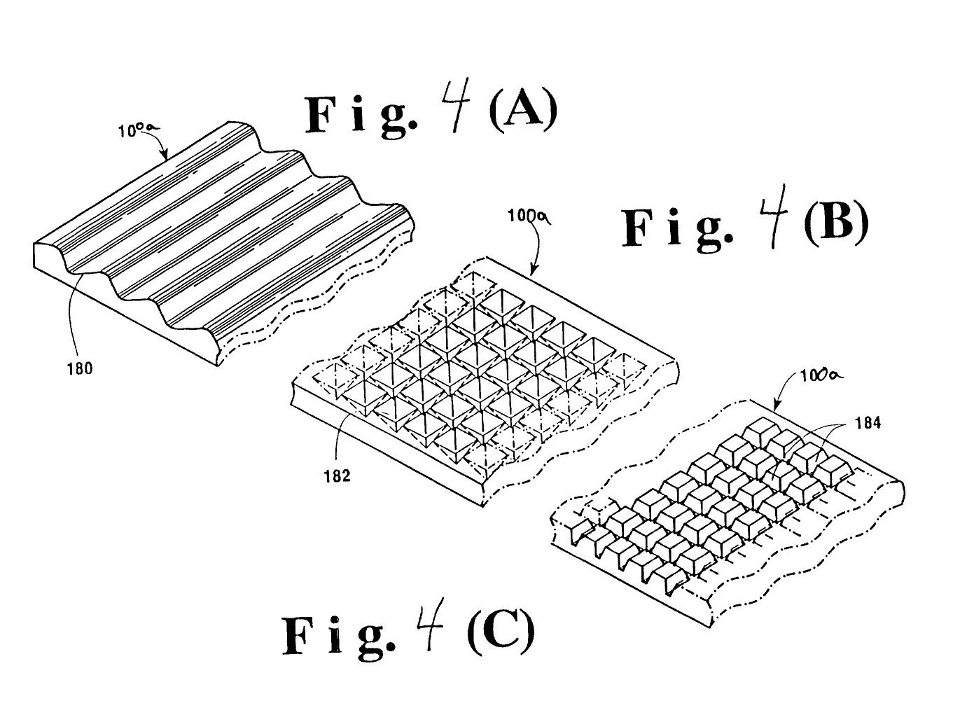

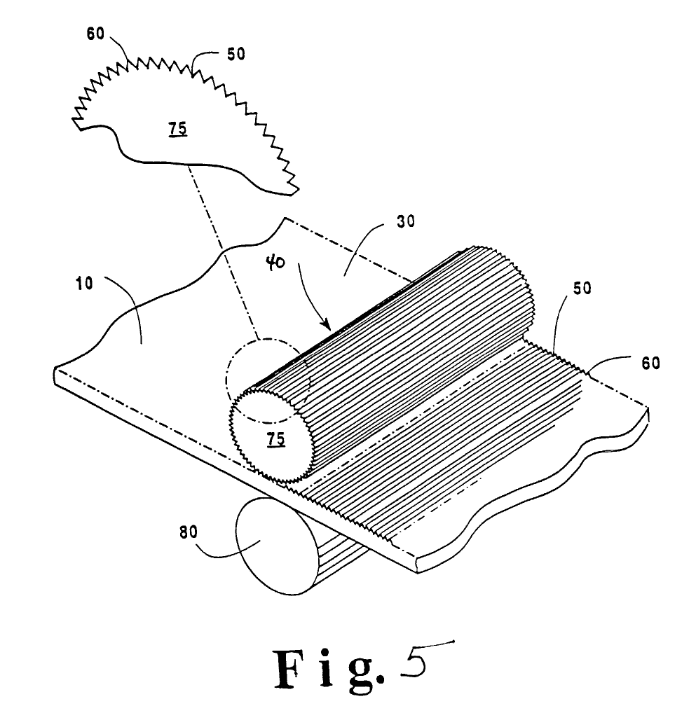

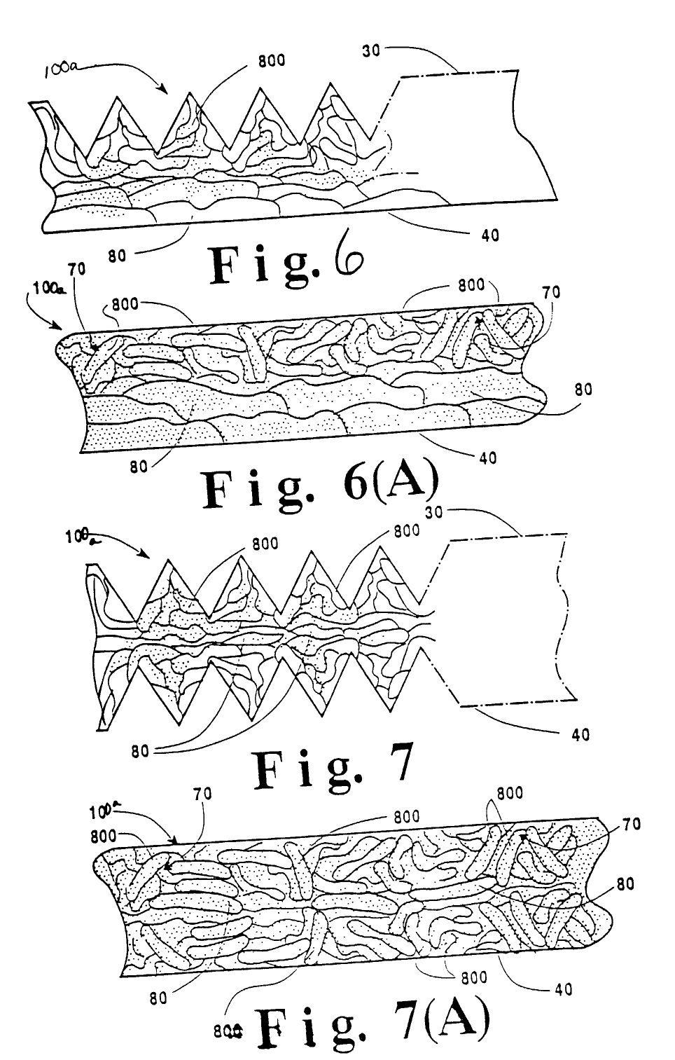

For example, a planar surface 30 of flexible graphite sheet 100a of FIG. 3 can be transversely deformed, advantageously in a continuous pattern, by mechanically impacting the planar surface 110 with penetration to a predetermined depth, e.g., ⅛ to ½ of the thickness of sheet 100a, to displace graphite within the sheet 100a, such as by means of a device 40 such as shown in FIG. 5 which includes a roller 75, having grooves 50 and ridges 60, co-acting with smooth surfaced roller 80 (alternate deformation patterns are illustrated in FIGS. 4(A)-4(C). The resulting article is illustrated in the side elevation view of FIG. 6. The misalignment of the graphite particles (and, therefore, the graphene layers) is due to displacement of graphite entirely within flexible graphite sheet 100a resulting from mechanical impact. The transversely deformed article of FIG. 6 is compressed, e.g. by roll-pressing, to restore the surface 30 to a planar condition as illustrated in FIG. 6(A). With reference to FIG. 6(A), after restoring surface 30 to a planar condition, sheet 100a has a region 70, adjacent planar surface 30, in which expanded graphite particles 800 are substantially unaligned with parallel, planar opposed surfaces 30, 40, resulting in a reduced anisotropic ratio (i.e., greater isotropy). With reference to FIG. 7, a flexible graphite sheet 10 can be transversely deformed at both opposed surfaces 30, 40 either sequentially or simultaneously, and subsequently compressed to provide planar, parallel opposed surfaces 30, 40 as shown in FIG. 7(A). The article of FIG. 7(A) has region 70 of substantially unaligned expanded graphite particles respectively adjacent both of the parallel, planar surfaces 30, 40, resulting in yet further reduced anisotropy.

Practice of the invention as described above permits control of the anisotropic characteristics of a graphite article. In this way, the article can be engineered so as to have optimized characteristics for each specific end use, whether it be heat management for electronic components or improved thermal and electrical management for fuel cell components.

The above description is intended to enable the person skilled in the art to practice the invention. It is not intended to detail all of the possible variations and modifications that will become apparent to the skilled worker upon reading the description. It is intended, however, that all such modifications and variations be included within the scope of the invention that is defined by the following claims. The claims are intended to cover the indicated elements and steps in any arrangement or sequence that is effective to meet the objectives intended for the invention, unless the context specifically indicates the contrary.

What is claimed is:

1. A process for producing a finished graphite article having a predetermined anisotropic characteristics, the process comprising:
a. determining the desired anisotropic characteristics for a finished flexible graphite article;
b. intercalating and then exfoliating flakes of graphite to form exfoliated graphite particles;
c. forming a substrate graphite article by compressing the exfoliated graphite particles into a coherent article formed of graphene layers;
d. producing a controlled directional alignment of the graphene layers in the substrate graphite article to provide a finished graphite article having the desired anisotropic characteristics.

2. The process of claim 1 wherein the flakes of graphite comprise flakes of natural graphite.

3. The process of claim 1 wherein the controlled directional alignment of the graphene layers is produced by:
a. molding of the exfoliated graphite particles to form the finished graphite article;
b. mechanically altering the orientation of the particles of the graphite article; or
c. combinations of any of the foregoing.

4. The process of claim 3 wherein the mechanical alteration of the substrate flexible graphite article can be effected by compaction of the substrate graphite article, the application of shear force to the substrate flexible graphite article, embossing of the substrate graphite article, localized impaction of the substrate graphite article, or combinations thereof.

5. The process of claim 1 wherein the desired anistropic characteristics comprise the anisotropic ratio.

6. The process of claim 5 wherein the anisotropic ratio is a thermal conductivity anisotropic ratio between about 2 and about 250.

7. The process of claim 5 wherein the anisotropic ratio is a thermal conductivity anisotropic ratio at least about 30.

8. The process of claim 5 wherein the anisotropic ratio is an electrical conductivity anisotropic ratio between about 200 and about 5000.

9. The process of claim 5 wherein the anisotropic ratio is an electrical conductivity anisotropic ratio of greater than about 2200.

10. The process of claim 5 wherein the desired anisotropic ratio is chosen to balance thermal and electrical conductivity in a controlled manner.

11. The process of claim 10 wherein the electrical anisotropic ratio is no greater than about 1500 and the thermal anisotropic ratio is greater than about 100.

12. The process of claim 1 wherein the graphite article is impregnated with a resin.

13. A graphite article prepared in accordance with the process of claim 1.

14. A graphite article prepared in accordance with the process of claim 3.

15. A graphite article prepared in accordance with the process of claim 10.

16. A graphite article comprising flakes of natural graphite which have been exfoliated and compressed into a graphite article having a predetermined anisotropic ratio.

17. The article of claim 16 wherein the anisotropic ratio is a thermal anisotropic ratio between about 2 and about 250.

18. The process of claim 16 wherein the anisotropic ratio is a thermal conductivity anisotropic ratio at least about 30.

19. The article of claim 16 wherein the anisotropic ratio is an electrical anisotropic ratio between about 200 and about 5000.

20. The process of claim 16 wherein the anisotropic ratio is an electrical conductivity anisotropic ratio of greater than about 2200.

21. The process of claim 16 wherein the desired anisotropic ratio is chosen to balance thermal and electrical conductivity in a controlled manner.

22. The process of claim 21 wherein the electrical anisotropic ratio is no greater than about 1500 and the thermal anisotropic ratio is greater than about 100.

23. The article of claim 16 wherein the predetermined anisotropic ratio is produced by controlled directional alignment of the graphene layers by:
a. molding of the exfoliated graphite particles to form the finished graphite article;
b. mechanically altering the orientation of the particles of the graphite article; or
c. combinations of any of the foregoing.

24. The article of claim 23 wherein the mechanical alteration of the orientation of the particles of the flexible graphite article is effected by compaction of the substrate graphite article, the application of shear force to the substrate flexible graphite article, embossing of the substrate flexible graphite article, localized impaction of the substrate flexible graphite article, or combinations thereof.

25. The article of claim 16 which is impregnated with resin.
